(19) United States
(12) Patent Application Publication
(10) Pub. No.: US 2002/0059959 A1
(43) Pub. Date: May 23, 2002

(54) System and apparatus for noise suppression in a fluid line

(76) Inventors: Mohamad S. Qatu, Bloomfield Hills, MI (US); Donald Liness Walker, Lake Orion, MI (US); Jack Abner, Columbia City, IN (US)

Correspondence Address: ROBERT C. COLLINS, REISING, ETHINGTON, BARNES,KISSELLE,LEARMAN, ET AL, P.O. BOX 4390, TROY, MI, 48099, US

(21) Appl. No.: 10/042,538

(22) Filed: Jan. 8, 2002

(51) Int. Cl. F16L 55/04

(52) U.S. Cl. 138/30

(57) ABSTRACT

Apparatus for reducing fluid-borne noise in a hydraulic system that includes a housing that defines a hollow chamber, and inlet and outlet connections for in-line connecting the apparatus in a hydraulic fluid flow system. A resilient member is disposed within the housing and effectively divides the housing chamber into a first portion adjacent to the fluid inlet and outlet for receiving hydraulic fluid, and a second portion remote from the fluid inlet and outlet for containing gas under pressure. Pressure pulsations in the hydraulic fluid are reduced and at least partially absorbed by the combined effect of resiliency of the elastic member and compressibility of the contained gas.

The present invention relates to suppression of fluid-borne noise in hydraulic or fluid handling systems, such as automotive power steering, power brake, air conditioning and fuel distribution systems.

### BACKGROUND AND OBJECTS OF THE INVENTION

There are many applications in industry and commerce where it is desirable to suppress fluid-borne noise in hydraulic power systems and other fluid handling systems. As an example, it is desirable to attenuate or suppress fluid-borne noise generated by the pump or fluid valving in automotive power steering, power brake, fuel distribution and air conditioning systems. It is also desirable to suppress compressor noise in domestic and commercial air conditioning systems. Fluid-borne noise can also be a problem in various industrial hydraulic systems where the fluid pressure pulses generate an audible and objectionable noise causing both wear and fatigue of system components, and which can also exceed OSHA requirements.

The inherent design of fluid pumps, whether driven by an internal combustion engine, an electric motor or by fluid system valves, causes pressure fluctuations or pulses in the fluid line that generate fluid-borne noise. The pistons, gerotors, gears, vanes or other fluid displacement elements that pump the fluid cause pressure fluctuations, ripple or pulses within the fluid at a frequency that is dependent upon pump speed. The geometry and inherent characteristic of the pump can also be sources of fluid pressure fluctuations and vibrations. This fluid ripple can be a source of audible and objectionable noise, and can also excite components along its path (e.g., the steering gear in power steering) to cause them to become secondary generators of such noise.

During normal operation of an automotive power steering system, for example, hydraulic fluid pressure can repetitively vary, and thereby generate a pressure-dependent wave form that can range substantially in amplitude between upper and lower limit values and induce system vibration. The frequency of such fluid-borne vibration can also vary substantially with the speed of the driving component (e.g., an engine) and other factors. It has been proposed to use expansible-type hoses as the fluid conductors in fluid systems in order to dampen and absorb such fluid-borne vibrations. These hoses typically consist of a tube of rubber or another elastomeric material, which is reinforced by braiding that consists of nylon or a similar material. The braiding may be disposed within the outer circumference of the tubing, or may be disposed within a layer of elastomeric material that is itself disposed around the outside of the tubing. The soft compressible elastic material of expansible hose expands upon pressure to absorb pressure fluctuations in the fluid. The strengthening braid also allows some degree of expansion when subjected to pressure.

Expansible hoses are wide-band devices and, in principle, can respond to fluid vibrations over a wide frequency range. For satisfactory performance, there must be enough expansion capability in the elastomeric hose material to absorb the pressure fluctuations over the amplitude and frequency range encountered in the fluid system. However, this is possible only when the changes in volume flow rate associated with the pressure ripples are less than the volume expansion capability of the hose for the same change in hydraulic fluid pressure.

Accordingly, to dampen the fluctuation even further, an attenuator in the form of a tuner conduit made of spirally constructed steel or nylon has been used within the hose. This tuner usually permits the fluid to flow from within its bore into the annulus or chamber formed between the tuner o.d. and the hose i.d. or bore. The fluid flowing in this annulus meets the fluid which is flowing inside the tuner bore at the downstream end of the tuner length.

In a hydraulic fluid flow system, the pressurized hydraulic fluid output of the pump has both a mean pressure value and a pressure variation, pulsation or ripple. This fluid ripple acts as a dynamic force at a hydraulic bend, connection or end point, as does the steering gear in a power steering system. This dynamic force causes vibration of the fluid line itself and/or the structure connected to it. Vibrating surfaces cause audible and objectionable noise and are sources of discomfort in vehicles with hydraulic lines. In order to minimize this noise, the fluid pressure ripple has to be minimized or even eliminated. In current technology, hoses with tuners are being used on a trial and error basis to provide attenuation of the fluid ripple. Tuners are basically flexible conduit inserts that can be used coaxially inside a hose.

It is recognized that there are two mechanisms that work to reduce such a ripple. The first is damping. The elastic hose lining and the fluid in the annular chamber (as well as expansion and contraction of the tuner conduit when made as an elastic structure) work conjointly as a damper to reduce the excitation of the ripple. Such damping is a mechanism that works for all frequencies. It is, therefore, referred to as broadband. The second mechanism is wave cancellation.

Among the objects of the present invention are to provide apparatus for suppressing fluid-borne noise in hydraulic systems, such as automotive power steering, power brake, fuel distribution and air conditioning systems, that are economical to implement and reliable over an extended operating lifetime, where a hose system configuration can be employed in a variety of applications, and that are passive in operation and require no input of electrical or any other form of power.

Further objects are to provide an improved system and apparatus offering increased flexibility of design, using conventional software that has been developed to simulate hydraulic lines with a traveling wave, and that utilize the phenomenon or mechanisms of fluid body and hose lines damping together with the phenomenon or mechanisms of fluid body and hose line damping together with the phenomena or mechanism of wave cancellation in order substantially to attenuate fluid ripple in the system as well as at the wave source (e.g., the pump) for particular frequencies found most objectionable in a given system and application.

### BRIEF DESCRIPTION OF THE DRAWINGS

The invention, together with additional objects, features and advantages thereof, will be best understood from the following description, the appended claims and the accompanying drawings in which:

FIG. 1 is a schematic diagram of a fluid handling system equipped with improved fluid-borne noise suppression apparatus in accordance with a presently preferred embodiment of the invention;

FIG. 2 is a sectional view on an enlarged scale of a portion of the system illustrated in FIG. 1;

FIGS. 2A and 2B are sectional views that illustrate respective modifications to the embodiment of FIG. 2;

FIG. 3 is a sectional view taken substantially along the line 3-3 in FIG. 2;

FIGS. 4-9 are sectional views similar to that of FIG. 2 but showing respective additional modified embodiments of the invention;

FIGS. 10 and 11 are sectional views that illustrate respective further embodiments of the invention;

FIG. 12 is a sectional view that illustrates a further embodiment of the invention; and

FIG. 13 is a sectional view that illustrates yet another embodiment of the invention.

### DETAILED DESCRIPTION OF PREFERRED EMBODIMENTS

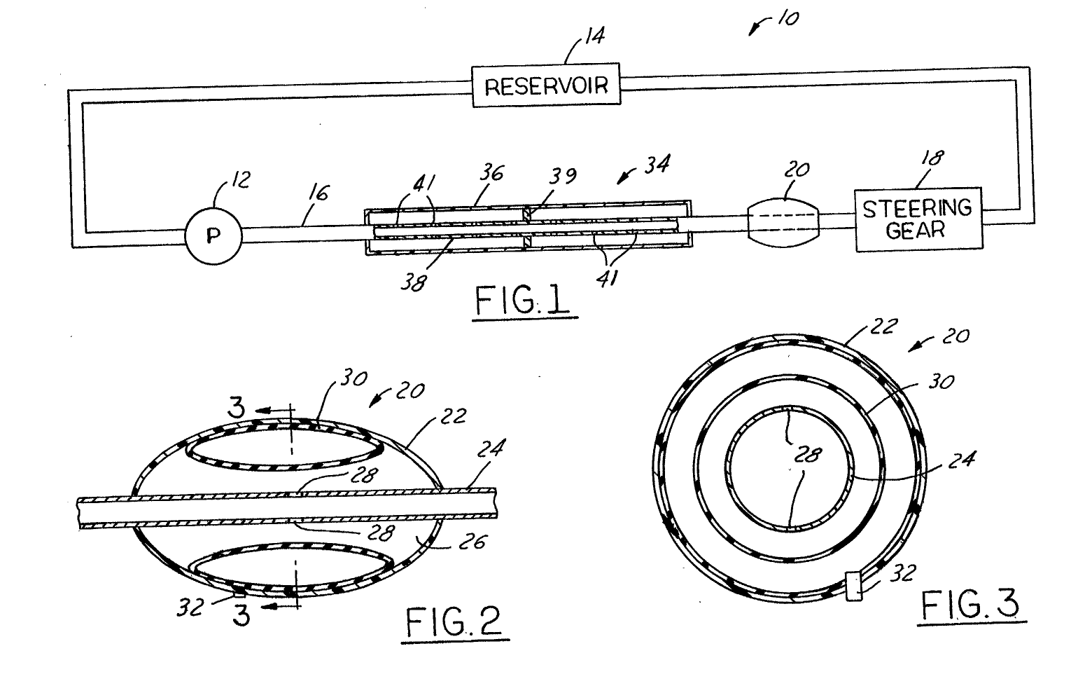

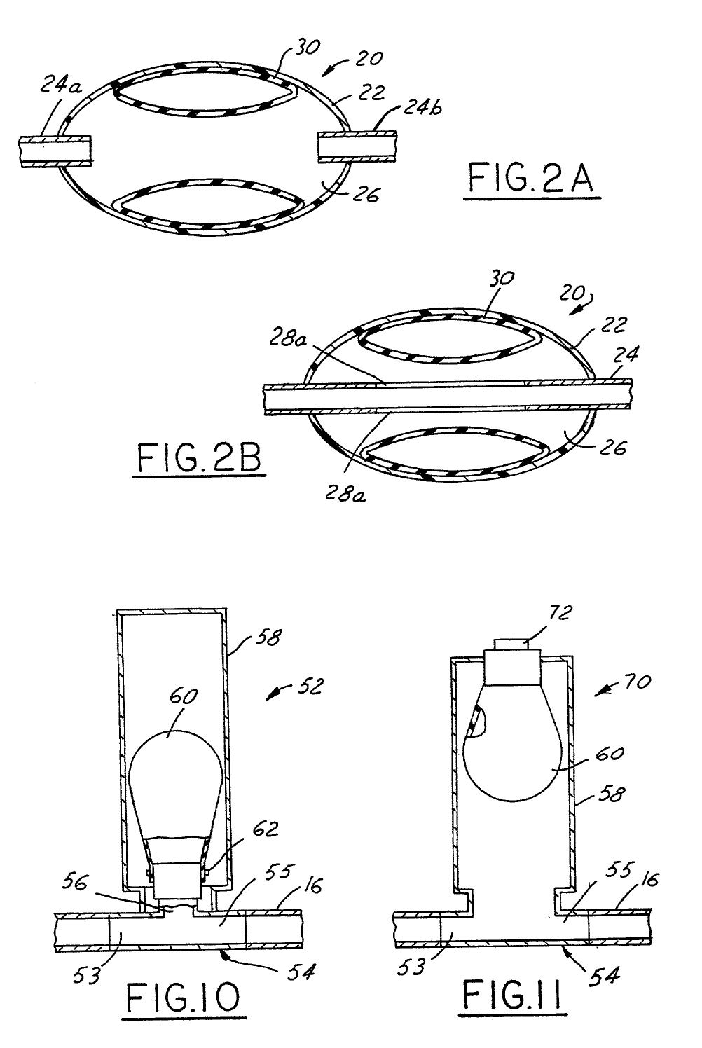

FIG. 1 is a schematic diagram that illustrates a fluid handling system in the form of a hydraulically actuated power steering system 10. Power steering system 10 includes a pump 12 for applying hydraulic fluid under pressure from a reservoir 14 through a closed-circuit fluid flow line 16 to a steering gear load 18. Apparatus 20 (FIGS. 1-3) in accordance with the present invention is connected in fluid flow line 16, between pump 12 and steering gear 18 in the schematic illustration of FIG. 1, for suppressing fluid-borne noise in the hydraulic fluid flowing through the system.

Apparatus 20 includes a housing 22 of metal or plastic construction, preferably having an ovate longitudinal cross section (FIG. 2) and a circular transverse cross section in (FIG. 3). A fluid conduit or pipe 24, also of metal or plastic construction, extends longitudinally through housing 22 for connection at opposed ends in fluid flow line 16. Thus, fluid flowing through the closed path of system 10 flows through conduit 24 within housing 22. Housing 22 thus defines an annular chamber 26 within the housing surrounding conduit 24. Conduit 24 has at least one passage or hole 28, preferably diametrically opposed passages 28 in the embodiment of FIGS. 2-3, opening radially outwardly into chamber 26.

A hollow annular bladder 30 is disposed within chamber 26 surrounding conduit 24. Bladder 30 is preferably secured to the inner surface of housing 22 spaced radially outwardly from conduit 24 and in spaced opposition to passages 28, which in the illustrated embodiment are mid-way along the longitudinal dimension of housing 22. A valve 32 (FIG. 3) is carried by bladder 30 and extends through housing 22 for selectively varying pressure of gas within the bladder.

Fluid flowing through system 10 thus passes through conduit 24 within housing 22. This fluid fills chamber 26 through passages 28. Pressure pulsations within the fluid flow into chamber 26 and are damped by resilient compression of gas-filled bladder 30. The composition of bladder 30 and the gas employed within the bladder may be selected depending upon application. For example, for automotive power steering applications, the bladder should be able to withstand temperatures up to 250° F. and pressures of up to 1,500 psi. Length and diameter of housing 22 and bladder 30 may be selected as a function of application. It is anticipated that, in some applications, bladder 30 will be fixed with gas at a desired pressure during the manufacturing process, and valve 32 will not be needed. It is also anticipated that the gas within bladder 30 will normally be air. Nitrogen is envisioned as a likely alternative in many applications.

System 10 in FIG. 1 also preferably includes a noise-suppression tuner assembly 34. Tuner assembly 34 is disclosed in greater detail in U.S. Application Ser. No.09/346,462 filed Jul. 1, 1999 and assigned to the assignee hereof. The disclosure of this copending application is incorporated herein by reference for purposes of background. In general, tuner assembly 34 includes a fluid conduit 36 connected at opposite ends in flow line 16. A flexible inner tune 38 is coaxially mounted in conduit 36 and sized relative to conduit 36 to form a main conduit internally of tube 38 and an annular space between conduit 36 and tube 38. A restrictor 39 is mounted in the annular space between tube 38 and conduit 36, subdividing this annular space into axially adjacent annular sub-spaces. A multiplicity of apertures 41 open radially through tube 38 into the annular sub-spaces, each providing fluid communication to the annular sub-spaces. In this way, each of the annular subspaces serves as a fluid pulsation-absorption side-branch of tuner 34.

Apparatus 20 in accordance with the present invention acts as a Helmholz resonator to tune or cancel one particular frequency of fluid-borne noise or its harmonics. The fluid-filled portion of apparatus 20 also provides higher mass in the fluid system, which will help impede acceleration of pressure waves and minimize resulting vibration from the system.

FIG. 2A illustrates a modification to the embodiment of FIG. 2, in which conduit 24 does not extend entirely through housing 22 as in the embodiment of FIG. 2, but rather forms spaced and separated inlet and outlet fittings 24a and 24b at opposed ends of housing 22. Thus, all fluid flowing through housing 22 enters chamber 26. FIG. 2B illustrates another modification to the embodiment of FIG. 2, in which opposed passages 28 in FIG. 2 are replaced by diametrically opposed elongated slots 28a that extend axially in the direction of conduit 24 and radially through the sidewall of the conduit.

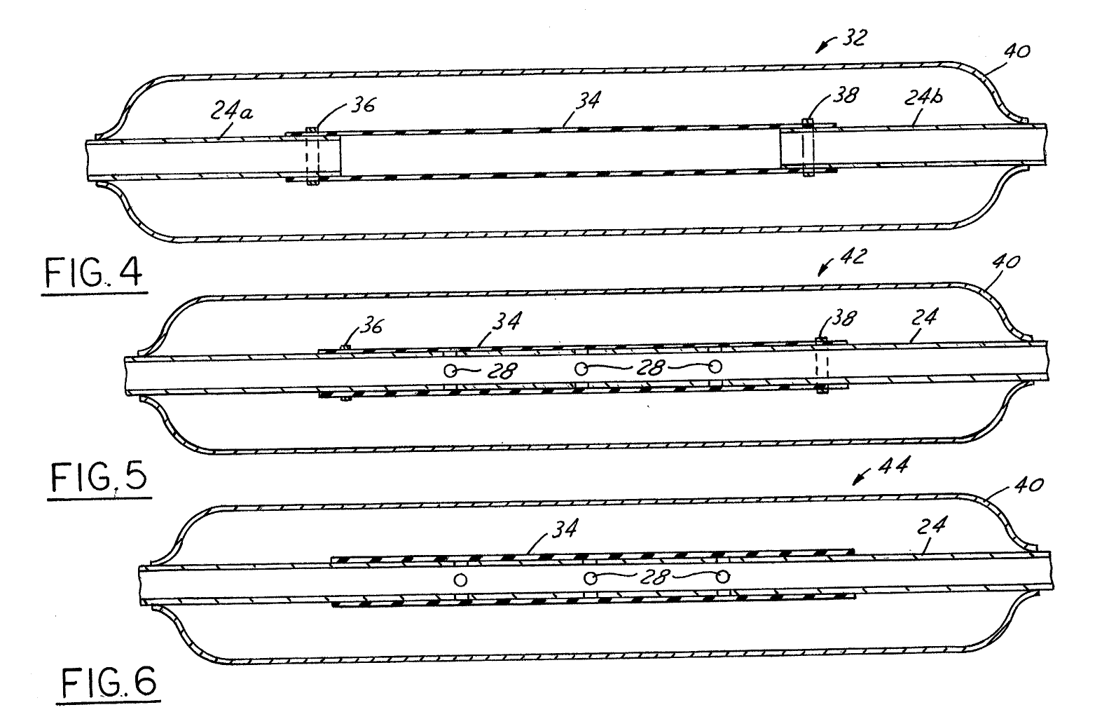

FIG. 4 illustrates an apparatus 32 for suppression of fluid-borne noise in accordance with another embodiment of the invention. Inlet and outlet fittings 24a, 24b are disposed in axial alignment at opposed ends of a housing 40. An elongated resilient sleeve 34 extends between and is coupled to the opposed ends of fittings 24a, 24b, being secured thereto by annular clamps 36, 38. Sleeve 34 may be of suitable rubber or elastomeric composition. Thus, fluid flowing between inlet fitting 24a and outlet fitting 24b flows through resilient sleeve 34. Housing 40 contains gas under pressure (e.g., air or nitrogen) exteriorally surrounding sleeve 34 (and fittings 24a, 24b). Thus, pressure fluctuations in fluid flowing through sleeve 34 expand the sleeve against the pressure of the surrounding gas, such that the combined effect of resiliency of sleeve 34 and compressibility of the gas reduces the amplitude of the fluid pressure fluctuations, and thus reduce fluid-borne noise.

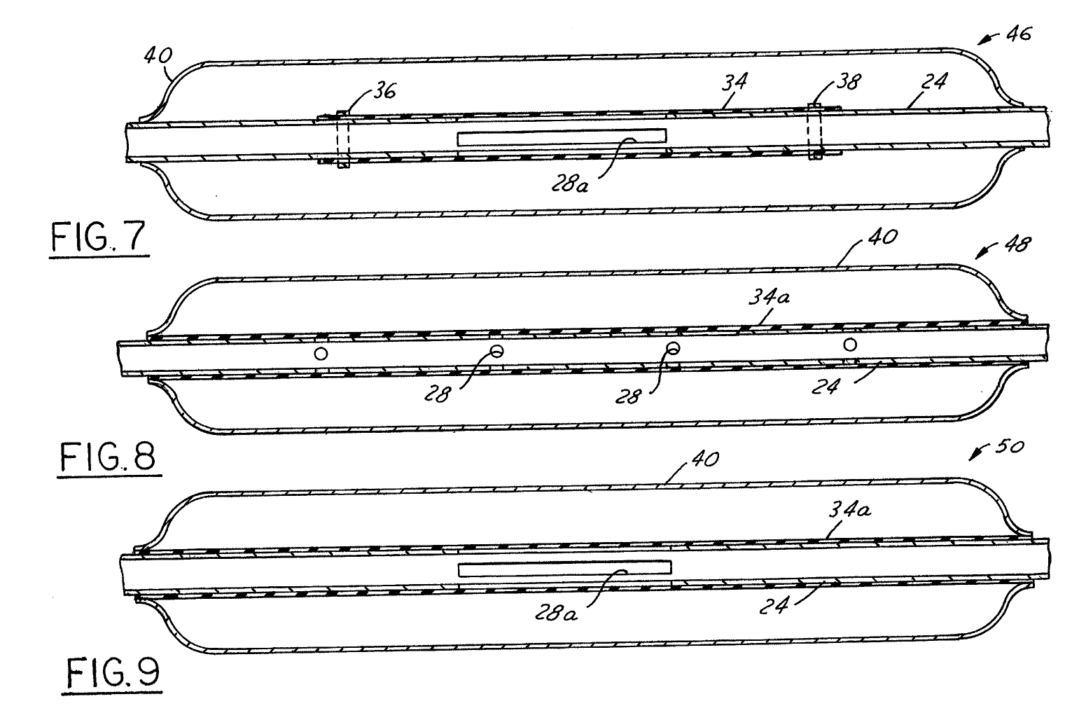

FIGS. 5-9 illustrate modifications to the embodiment of FIG. 4, in which like reference numerals indicate like components. In apparatus 42 of FIG. 5, conduit 24 extends entirely through housing 40, and has a plurality of openings or passages 28 that extend radially through the wall of the conduit. Resilient sleeve 34 is externally secured to conduit 24 over openings 28, being affixed to the conduit by clamps 36,38. Once again, the interior of housing 40 surrounding conduit 24 and sleeve 34 is filled with gas under pressure. Thus, pressure fluctuations in fluid flowing through conduit 24 pass radially outwardly through openings 28, and are absorbed by the combined effect of elasticity of sleeve 34 and compressibility of the gas within housing 40, as previously discussed. The apparatus 44 of FIG. 6 is similar to that of FIG. 5, except that clamps 36, 38 in FIG. 5 are excluded. Sleeve 34 is secured to conduit 24 by elasticity of the sleeve, with addition of adhesive between the spaced ends of sleeve 34 and the opposing surface of conduit 24 if desired. Apparatus 46 in FIG. 7 is again similar to that of FIG. 5, except that circular openings or passages 28 in conduit (FIG. 5) are replaced by axially elongated slots 28a.

In the embodiments 48, 50 of FIGS. 8 and 9, the sleeve 34a is axially elongated as compared with sleeve 34 in FIGS. 4-7, and is secured to conduit 24 by deformation of housing 40 over sleeve 34a around conduit 24. That is, housing 40 in FIGS. 8 and 9 is of suitable malleable material, such as sheet metal, that is crimped or otherwise deformed over the axially spaced ends of sleeve 34a so as to secure both sleeve 34a and conduit 24 within housing 40. (In the embodiments of FIGS. 4-7, housing 46 is crimped or otherwise secured directly to conduit 24 or fittings 24a, 24b.) Thus, in these embodiments, the axially spaced ends of sleeve 34a serve the additional function of sealing housing 40 to conduit 26.

FIG. 10 illustrates an apparatus 52 in accordance with another embodiment of the invention, in which a T-fitting 54 has axially aligned legs 53, 55 that provide for in-line connection to fluid line 16 (FIGS. 1 and 10), and a side leg 56 that is connected through the wall of a housing 58. A rubber or elastomeric bladder 60 is secured by a clamp 62 to leg 56 within housing 58. The volume of housing 58 surrounding bladder 60 contains gas under pressure fed thereto by a suitable valve (not shown). Thus, pressure fluctuations in the fluid flowing through line 16 are fed laterally into bladder 60, and are absorbed by the combined effect of resiliency of bladder 60 and compressibility of the gas within housing 58.

FIG. 11 illustrates an apparatus 64 that is similar to that of FIG. 10, but in which bladder 60 contains gas under pressure rather than hydraulic fluid. That is, bladder 60 is coupled to a valve 72 that is carried by housing 58. Housing 58 is again coupled to fluid line 16 by T-fitting 54. Thus, the exterior of bladder 60 is engaged by hydraulic fluid fed to housing 58 by fitting 54, while the interior of bladder 60 contains gas under pressure. Thus, as in the embodiment of FIGS. 1-3, fluid pressure fluctuations are absorbed by the combined effect of resiliency of bladder 60 and compressibility of the gas contained within the bladder.

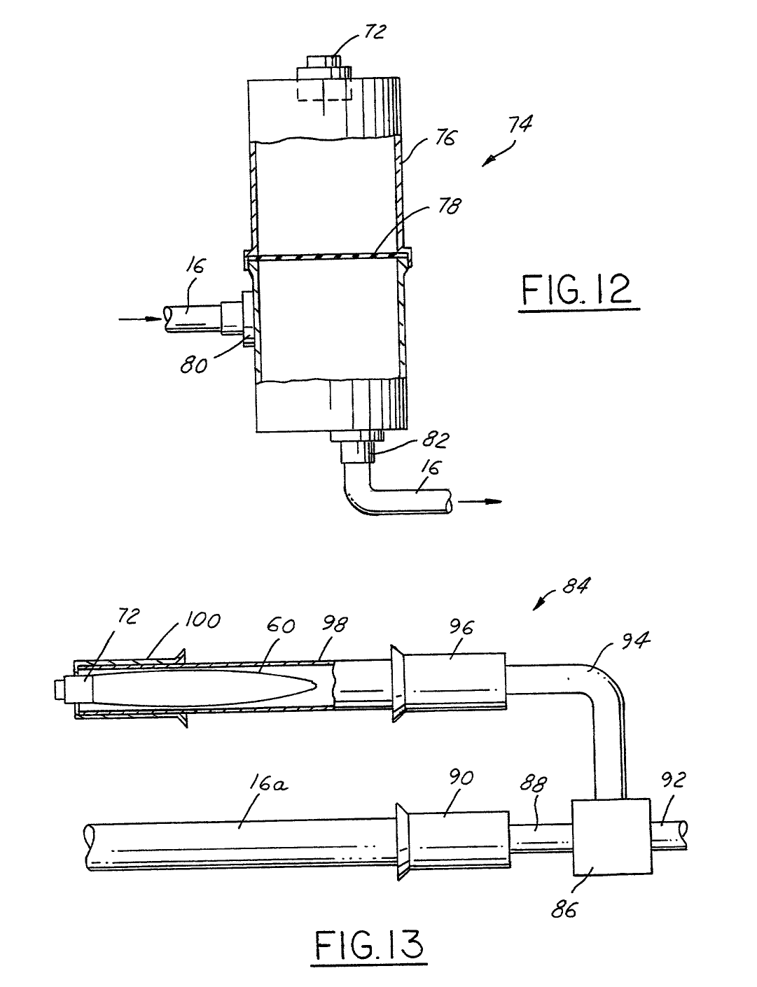

FIG. 12 illustrates an apparatus 74, in which an enclosure 76 is internally divided by a flexible diaphragm 78 of rubber or elastomeric composition. On one side of diaphragm 78, enclosure 76 has an inlet fitting 80 and an outlet fitting 82 for in-line connection to fluid flow line 16. Thus, the fluid flowing from outlet fitting 82 fills that portion of housing 76 on one side of diaphragm 78. The opposing portion of housing 76 is filled with gas under pressure through a valve 72.

FIG. 13 illustrates an embodiment 84 that is similar to many respects to the embodiment 70 in FIG. 11. A T-coupling 86 is connected by a pipe 88 to a coupling 90. Coupling 90 is connected to a fluid hose 16a, and coupling 86 is connected by a second pipe 92 to fluid line 16 (FIG. 1). A pipe 94 extends laterally from coupling 86 to a coupling 96, which connects to a hose 98. The opposing end of hose 98 is closed by a coupling 100 that carries a valve for feeding gas (such as air) under pressure to a closed bladder 60.

In all of the disclosed embodiments, hydraulic fluid is separated from gas under pressure by a resilient member, such as a bladder, sleeve or diaphragm. In all embodiments, pressure fluctuations are absorbed, at least in part, by the combined effect of resiliency of the resilient member and compressibility of the gas. In the disclosed embodiments, the gas chamber may be either filled and sealed, as at the factory or at the time of installation, or may be coupled to dynamic gas pressure control means.

There has thus been disclosed an apparatus for suppressing fluid-borne noise in a hydraulic system that fully satisfies all of the objects and aims previously set forth. Several alternative embodiments and associated modifications have been disclosed. Other modifications and variations will suggest themselves to persons of ordinary skill in the art. The present invention is intended to encompass all such modifications and variations as fall within the spirit and broad scope of the appended claims.

1. Apparatus for reducing fluid-borne noise in a hydraulic system, which comprises:
a housing that defines a hollow chamber having means for in-line connecting said chamber in a hydraulic fluid-flow system, and
a closed bladder in said chamber for filling with gas to absorb pressure pulsations in fluid flowing through said housing.

2. The apparatus set forth in claim 1 wherein said connecting means comprises a fluid conduit that extends through said housing and has at least one passage opening into said chamber within said housing surrounding said conduit.

3. The apparatus set forth in claim 1 wherein said connecting means comprises spaced inlet and outlet fittings on said housing.

4. The apparatus set forth in claim 1 wherein said chamber and said bladder surround said connecting means.

5. The apparatus set forth in claim 1 wherein said chamber extends to one side of said connecting means.

6. The apparatus set forth in claim 1 wherein said bladder comprises an annular hollow construction that extends around an inner surface of said housing spaced from said conduit.

7. The apparatus set forth in claim 6 wherein said housing is of ovate cross section longitudinally of said conduit and circular cross section transversely of said conduit.

8. The apparatus set forth in claim 1 further comprising a valve on said housing coupled to said bladder for selectively varying quantity of gas in said bladder.

9. In a hydraulic fluid system that includes a pump and a load interconnected by a fluid flow line, means for suppressing fluid-borne noise in said fluid flow line comprising:
a housing that defines a hollow internal chamber having means at opposed ends connected to said line such that fluid flowing in said line flows through said housing, and
a closed gas-filled bladder in said chamber for absorbing pressure pulsations in fluid flowing through said housing.

10. The system set forth in claim 9 wherein said connecting means comprises a fluid conduit that extends through said housing and has at least one passage opening into said chamber within said housing surrounding said conduit.

11. The system set forth in claim 9 wherein said connecting means comprises spaced inlet and outlet fittings on said housing.

12. The system set forth in claim 9 wherein said bladder comprises an annular hollow construction that extends around an inner surface of said housing spaced from said conduit.

13. The system set forth in claim 12 wherein said housing is of ovate cross section longitudinally of said conduit and circular cross section transversely of said conduit.

14. The system set forth in claim 9 further comprising a valve on said housing coupled to said bladder for selectively varying quantity of gas in said bladder.

15. The system set forth in claim 9 further comprising a tuner assembly that includes:
a fluid conduit adapted to be fixed at opposite ends to said flow line,
a flexible inner tube coaxially mounted in said fluid conduit and sized relative thereto to form a main conduit internally of said tube and to form an annular space between said fluid conduit and said inner tube,
said inner tube being fixed at its opposite end portions to said flow line,
a restrictor in said annular space subdividing the same longitudinally into annular sub-spaces, and
aperture means through said flexible inner tube each for providing fluid communication to said annular sub-spaces between said fluid conduit and said inner tube on each side of said restrictor, such that each of said annular sub-spaces serves as a fluid pulsation-absorption side-branch of said device.

16. Apparatus for suppression of fluid-borne noise in a hydraulic system, which comprises,
a housing that defines a hollow chamber,
spaced inlet and outlet fittings carried by said housing for in-line connecting said chamber in a hydraulic fluid flow system, said chamber being open between said fittings such that fluid flowing between said fittings flows through said chamber, and
resilient means dividing said chamber into a fluid portion in a side of said resilient means that includes said fittings and a gas portion for containing gas under pressure to accommodate fluctuation of said resilient means and thereby absorb pressure fluctuations in said fluid portion of said chamber.

17. The apparatus set forth in claim 16 wherein said resilient means comprises an elongated sleeve extending between said inlet and outlet fittings within said chamber.

18. The apparatus set forth in claim 16 wherein said resilient means comprises a closed gas-filled b ladder within said chamber.

19. The apparatus set forth in claim 16 wherein said resilient means comprises a diaphragm that extends across said chamber and divides said chamber into said fluid and gas portions.

20. Apparatus for reducing fluid-borne noise in a hydraulic system, which comprises:
a housing that defines a hollow chamber having a conduit that extends through said housing for in-line connection to a hydraulic fluid flow system,
said conduit having a wall with at least one axially elongated slot that opens radially into said chamber, and
resilient means dividing said chamber into a fluid portion surrounding said conduit and a gas portion remote from said conduit for containing gas under pressure to accommodate fluctuations of said resilient means and thereby absorb pressure fluctuations in said fluid portion of said chamber.

21. The apparatus set forth in claim 20 wherein said conduit has a circumferential array of slots that extend through said conduit wall into said chamber.

22. The apparatus set forth in claim 20 wherein said housing is of ovate cross section longitudinally of said conduit and circular cross section transversely of said conduit.

23. The apparatus set forth in claim 20 further comprising a valve on said housing coupled to said bladder for selectively varying quantity of gas in said bladder.

24. Apparatus for reducing fluid-borne noise in a hydraulic system, which comprises:
a housing that defines a hollow chamber,
spaced inlet and outlet means for in-line connection in a hydraulic fluid flow system, and
an elongated resilient sleeve extending within said housing between inlet and outlet means, and dividing said chamber into a fluid portion adjacent to said inlet and outlet means and a gas portion for containing gas under pressure remote from said inlet and outlet means,
ends of said sleeve being disposed between said housing and said inlet and outlet means, and said housing being deformed over said sleeve ends to secure said sleeve and said inlet and outlet means to said housing, with said sleeve ends sealing said housing to said inlet and outlet means.

25. The apparatus set forth in claim 24 wherein said inlet and outlet means comprise a conduit extending through said housing and having radial passages that open into said fluid portion of said chamber.

26. The apparatus set forth in claim 25 wherein said radial passages comprise elongated slots that extend axially along said conduit.
